(19) United States
(12) Patent Application Publication
(10) Pub. No.: US 2023/0298337 A1
(43) Pub. Date: Sep. 21, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM BUSINESS INNOVATION CORP., Tokyo (JP)

(72) Inventor: Tadao MICHIMURA, Kanagawa (JP)

(73) Assignee: FUJIFILM BUSINESS INNOVATION CORP., Tokyo (JP)

(21) Appl. No.: 17/874,480

(22) Filed: Jul. 27, 2022

(30) Foreign Application Priority Data
Mar. 18, 2022 (JP) 2022-044189

(51) Int. Cl. G06V 10/84; G06V 10/25; G06V 10/77; G06T 7/11

(52) U.S. Cl. CPC G06V 10/84; G06V 10/25; G06V 10/7715; G06T 7/11; G06T 2207/20076; G06T 2207/30136

(57) ABSTRACT

An information processing apparatus including a memory and a processor configured to: divide a drawing image with one or more modified portions shown into multiple regions, and generate and store, in the memory, a first estimation model to estimate a probability value of modification per region in a drawing by performing machine learning using, as teacher data, a position of a region including a modified portion on the drawing, and a feature value extracted from an image of each of the multiple regions; divide, upon receiving a drawing image to be inspected, the received drawing image into a multiple regions, and extract a feature value from an image of each of the divided regions; and estimate a probability value per region in the received drawing image by inputting the extracted feature value to the first estimation model stored in the memory.

### CROSS-REFERENCE TO RELATED APPLICATIONS

This application is based on and claims priority under 35 USC 119 from Japanese Patent Application No. 2022-044189 filed Mar. 18, 2022.

### BACKGROUND

### (i) Technical Field

The present disclosure relates to an information processing apparatus, a non-transitory computer readable medium storing a program, and an information processing method.

### (ii) Related Art

Japanese Unexamined Patent Application Publication No. 2017-084224 discloses a design support apparatus, a non-transitory computer readable medium storing a program, and a design support method capable of quickly creating and presenting a design plan including a plan for a product never developed so far to a new customer request. For a design support system using a simulation in related art, and a component information database of the product, the design support apparatus estimates a customer request to a product of interest using customer requests to similar products, performs a simulation using an analysis model which can evaluate request items according to the estimated customer request, creates a product system design plan, and associates the created product system design plan with design items.

Japanese Unexamined Patent Application Publication No. 2019-095217 discloses a visual inspection apparatus capable of flexibly coping with the shape of an object to be inspected, and a new defect mode, the visual inspection apparatus including: a data pairing creation unit that selects and creates a pair of a first image which is an image of a normal product, and a second image which is an image of a target product for comparison based on reference data set and learning data sets from different data sets; and a machine learning apparatus that learns classification of whether a product corresponding to the second image is normal or defective, the machine learning apparatus including: a state observation unit that observes a pair of the first image and the second image as a state variable representing a current state of the environment; a label data acquisition unit that acquires a label assigned to the second image as label data; and a learning unit that learns the state variable and the label data by associating with each other.

Japanese Unexamined Patent Application Publication No. 2016-122293 discloses a drawing inspection support apparatus and a drawing inspection support method capable of detecting omission of dimensions of a component in a two-dimensional design drawing generated from a three-dimensional model. The drawing inspection support apparatus extracts a creation history a three-dimensional model which is the base of a two-dimensional design drawing to be inspected, and attribute items for each creation history, calculates a required number of dimension descriptions for the two-dimensional design drawing to be inspected, the required number being the total number of attribute items excluding those for which a description of dimensions is unnecessary for the two-dimensional design drawing to be inspected, compares the required number with the actual number of dimension descriptions, which is the total number of dimensions listed in the two-dimensional design drawing to be inspected, determines whether the actual number of dimension descriptions is sufficient or insufficient, and outputs a result of the determination.

“Application of artificial intelligence technology to product design” by Nozaki Naoyuki et al, FUJITSU. 67, 3, p. 58-65 (05, 2016), (https://www.fujitsu.com/jp/documents/about/resources/public ations/magazine/backnumber/vol67-3/paper10.pdf) discloses a technique which predicts the number of layers of substrates based on circuit design information using a learning model generated by a support vector machine, and detects those components having a high similarity with the components in the past in order to automatically detect the components of a 3D model in a structural system design.

### SUMMARY

When a drawing, such as an electrical circuit drawing, a plastic component drawing, and a sheet metal component drawing, is inspected, if which drawing has a high probability of modification among multiple drawings can be grasped based on the past modification history, the drawing having a high probability of modification can be reviewed intensively.

However, even when it is found that the probability of modification in a sheet of drawing is high, the entire drawing needs to be reviewed unless the part of the drawing having a high probability of modification is not known. If all parts of a sheet of drawing need to be reviewed, the greater the size and complexity of a sheet of a drawing, the significantly longer time is needed for the review.

Aspects of non-limiting embodiments of the present disclosure relate to providing an information processing apparatus, a non-transitory computer readable medium storing a program, and an information processing method which are capable of recognizing which part of the drawings has a high probability of modification.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a memory and a processor configured to: divide a drawing image with one or more modified portions shown into a plurality of regions, and generate and store, in the memory, a first estimation model to estimate a probability value of modification per region in a drawing by performing machine learning using, as teacher data, a position of a region including a modified portion on the drawing, and a feature value extracted from an image of each of the plurality of regions; divide, upon receiving a drawing image to be inspected, the received drawing image into a plurality of regions, and extract a feature value from an image of each of the divided regions; and estimate a probability value per region in the received drawing image by inputting the extracted feature value to the first estimation model stored in the memory.

### BRIEF DESCRIPTION OF THE DRAWINGS

Exemplary embodiments of the present disclosure will be described in detail based on the following figures, wherein:

FIG. 1 is a diagram illustrating a system configuration of a drawing inspection work support system in a first exemplary embodiment of the present disclosure;

FIG. 2 is a diagram illustrating a drawing image example which includes estimation results and is displayed on a display of a terminal apparatus;

FIG. 3 is a block diagram illustrating a hardware configuration of a drawing analysis server in the first exemplary embodiment of the present disclosure;

FIG. 4 is a block diagram illustrating a hardware configuration of the drawing analysis server in the first exemplary embodiment of the present disclosure;

FIG. 5 is a flowchart illustrating the flow of processing when a probability of modification per region in a drawing image to be inspected is estimated by the drawing analysis server in the first exemplary embodiment of the present disclosure;

FIG. 6 is a diagram illustrating a drawing image example to be inspected used for explaining the operation of the drawing analysis server in the first exemplary embodiment of the present disclosure;

FIG. 7 is a diagram illustrating a drawing image example which has undergone the cleansing processing;

FIG. 8 is a diagram illustrating the manner in which a drawing image to be inspected is divided into multiple regions;

FIG. 9 is a diagram illustrating the manner in which a modification probability estimator estimates a probability value while sliding the frame for 3×3 that is nine regions on the drawing image;

FIG. 10 is a chart illustrating the manner in which the modification probability estimator calculates a probability value of modification for each of nine regions by inputting vector data of feature values to an estimation model pre-stored in an estimation model storage;

FIG. 11 is a chart illustrating the manner in which the modification probability estimator estimates a minimum value among nine probability values as a probability value for a region of interest;

FIG. 12 is a chart illustrating a calculation example in which an average value is calculated from estimation results obtained when probability values are each estimated for a set of nine regions, and a probability value for each region is estimated;

FIG. 13 is a chart illustrating a calculation example in which a minimum value is calculated from estimation results obtained when probability values are each estimated for a set of nine regions, and a probability value for each region is estimated;

FIG. 14 is a diagram illustrating an evaluation result example output by an estimation result output unit;

FIG. 15 is a diagram illustrating an evaluation result example when there is no region with a probability value of 0.4 or higher, the probability value being estimated by the modification probability estimator;

FIG. 16 is a diagram when a drawing to be inspected is a plastic component drawing;

FIG. 17 is a diagram illustrating a processing result example after cleansing processing is executed on the plastic component drawing illustrated in FIG. 16;

FIG. 18 is a block diagram illustrating a functional configuration of a drawing analysis server in a drawing inspection work support system in a second exemplary embodiment of the present disclosure;

FIG. 19 is a chart illustrating an overview of the flow of processing in the drawing analysis server in the second exemplary embodiment of the present disclosure; and

FIG. 20 is a flowchart illustrating the flow of processing for estimating a probability of modification per region in a drawing image to be inspected by the drawing analysis server in the second exemplary embodiment of the present disclosure.

### DETAILED DESCRIPTION

Next, an exemplary embodiment of the present disclosure will be described in detail with reference to the drawings.

### First Exemplary Embodiment

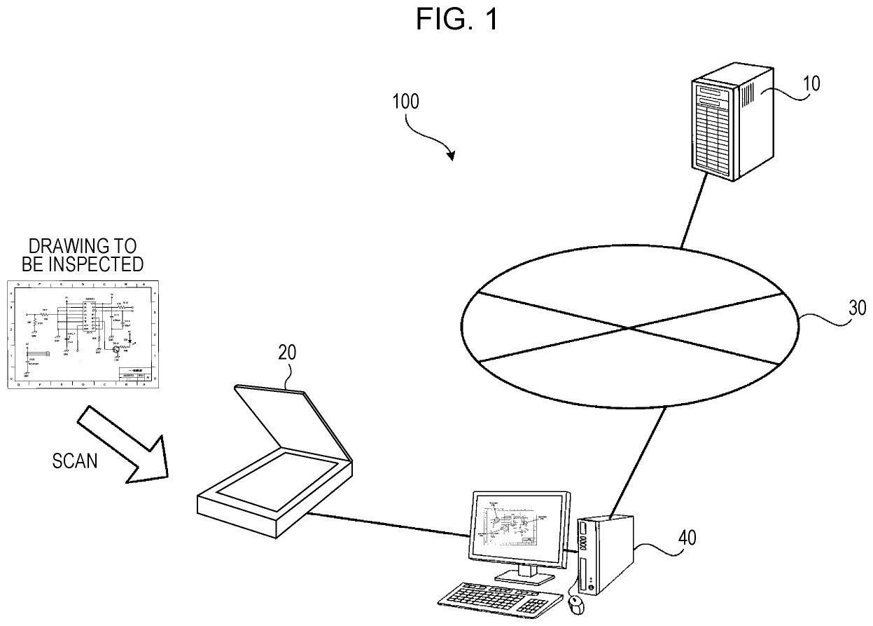

FIG. 1 is a diagram illustrating a system configuration of a drawing inspection work support system 100 in a first exemplary embodiment of the present disclosure.

When a new product is designed, various drawings, such as an electrical circuit drawing, a plastic component drawing, and a sheet metal component drawing, are created. Before the product is manufactured for trial or for mass production, inspection (or also called review) is made for the created drawings to confirm whether there is any problem in designed electrical circuit drawing, plastic component drawing, or sheet metal component drawing.

In recent years, due to development of component strength calculation system and simulator, problems such as deformation, tearing, and short circuit have been able to be logically detected at a design stage and coped with beforehand. Thus, after issuance of a component drawing, the number of times of modifying the drawing due to a problem based on logical contradiction has been decreased. However, due to incomplete parameter setting for performing calculation by the component strength calculation system and simulator, and/or specification change of relevant components, inspection by the component strength calculation system and simulator may be insufficient, and a defect may be overlooked. In addition, change in the drawing may be made because of a logically unexpected situation, such as design change for cost reduction in a later process after expensive excessive-quality design is made in order to place a priority on the safety of design.

In general, a component drawing, which is not modified since the issue of drawing until the start of mass production, is considered to have high quality. However, even when a component logically conforms to the specifications as a single unit without a problem, the component drawing may need to be modified if the component is incorporated and used in an actual product. Specifically, design change may be made in connection with occurrence of various problems, such as risk of finger squeeze due to narrow space between two components caused by insufficient consideration of operational safety, malfunction based on the difference between an assumed environment at design time and an actual use environment, and absence of a threaded hole for connecting to other component due to insufficient adjustment between relevant components.

In summary, even when a component conforms to the specifications as a single unit, it is difficult to completely avoid design change. A skilled designer can predict these factors for change in advance, and make a preventive setting in which change is unlikely to occur. However, a design beginner lacks such knowledge, and it is difficult to make a preventive design.

Furthermore, in recent years, due improvement of integration technology and production engineering, the complexity of component specifications has increased, and the number of drawing sheets has increased. Thus, a problem arises in that inspection of drawing cannot be effectively made by a third party.

The larger the volume of drawings to be inspected, the more time is taken for the inspection of drawing. Thus, the drawing inspection work support system 100 in the exemplary embodiment supports drawing inspection work when inspecting a drawing, such as an electrical circuit drawing, a plastic component drawing, and a sheet metal component drawing, by estimating which part of the drawing has a high probability of modification.

As illustrated in FIG. 1, the drawing inspection work support system 100 in the exemplary embodiment includes a drawing analysis server 10, a terminal apparatus 40, and a scanner 20.

The scanner 20 is connected to the terminal apparatus 40, and outputs drawing image data read from a drawing to be inspected to the terminal apparatus 40. The terminal apparatus 40 and the drawing analysis server 10 are coupled, for example, by the Internet 30. The terminal apparatus 40 transmits the drawing image data read by the scanner 20 to the drawing analysis server 10 via the Internet 30.

The drawing analysis server 10 receives the drawing image data transmitted from the terminal apparatus 40, and performs analysis on the drawing image to estimate which part of the drawing image has a high probability of modification. The drawing analysis server 10 then superimposes a result of the estimation on the drawing image, and transmits the drawing image to the terminal apparatus 40.

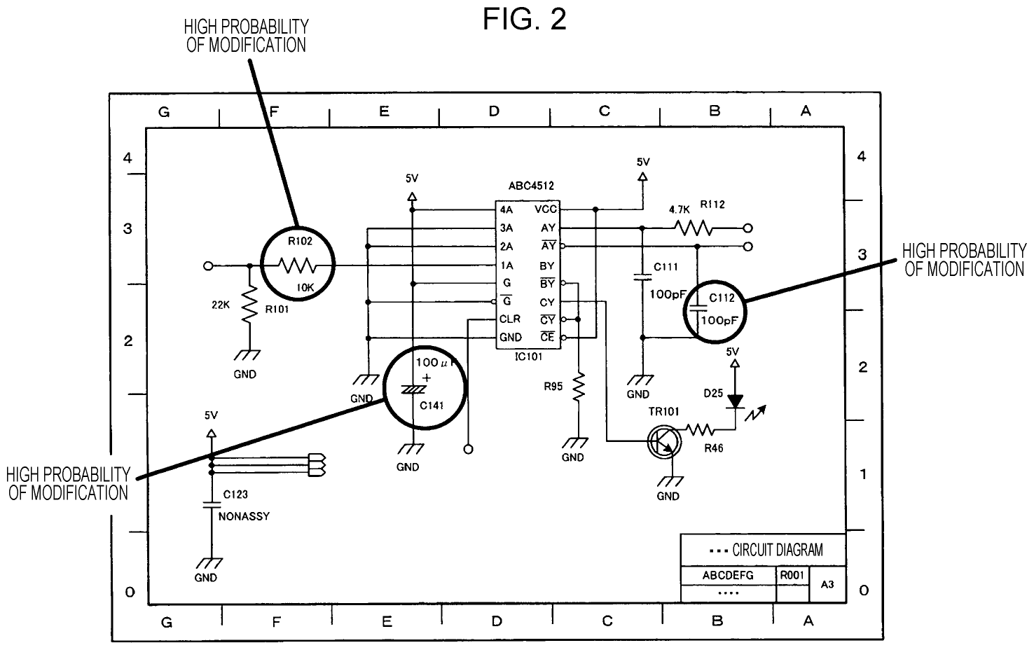

The terminal apparatus 40 displays, on its display, the drawing image including the estimation result transmitted from the drawing analysis server 10. A drawing image example including an estimation result, displayed on the display of the terminal apparatus 40 is illustrated in FIG. 2. Referring to FIG. 2, it is seen that an estimation result indicating portions with a high probability of modification is shown on an electrical circuit drawing.

When inspection of the electrical circuit drawing is made, problematic portions and portions need to be reviewed can be found in a shorter time by reviewing mainly the portions with a high probability of modification.

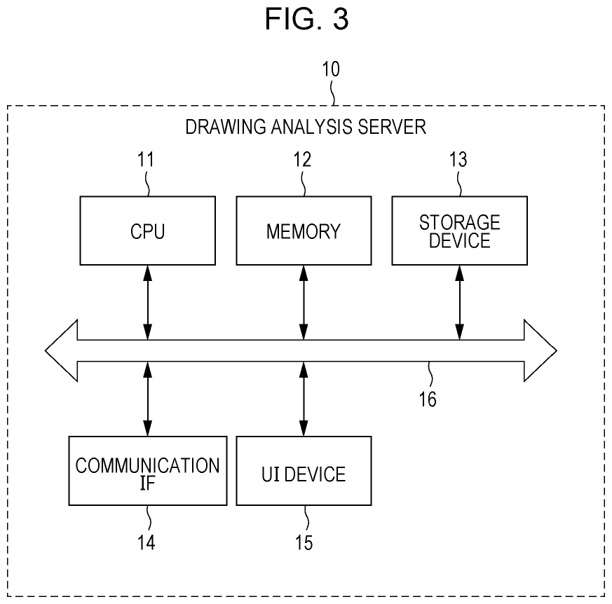

Next, the hardware configuration of the drawing analysis server 10 in the drawing inspection work support system 100 in the exemplary embodiment is illustrated in FIG. 3.

As illustrated in FIG. 3, the drawing analysis server 10 includes a storage device 13 such as a CPU 11, a memory 12, a hard disk drive; a communication interface (abbreviated as IF) 14 that transmits and receives data to and from an external apparatus via the Internet 30; and a user interface (abbreviated as UI) apparatus 15 including a touch panel or a liquid crystal display and a keyboard. These components are connected to each other via a control bus 16.

The CPU 11 is a processor that executes predetermined processing based on a control program stored in the memory 12 or the storage device 13 to control the operation of the drawing analysis server 10. Note that in the exemplary embodiment, the CPU 11 has been described as a processor that executes predetermined processing based on a control program stored in the memory 12 or the storage device 13; however, the exemplary embodiment is not limited to this. The control program may be provided in a form recorded in a computer-readable recording medium. For example, the control program may be provided in a form recorded in an optical disk such as a compact disc (CD)-ROM and a digital versatile disc (DVD) ROM, or a form recorded in a semiconductor memory such as a universal serial bus (USB) memory and a memory card. Alternatively, the control program may be obtained from an external apparatus via a communication line connected to the communication IF 14.

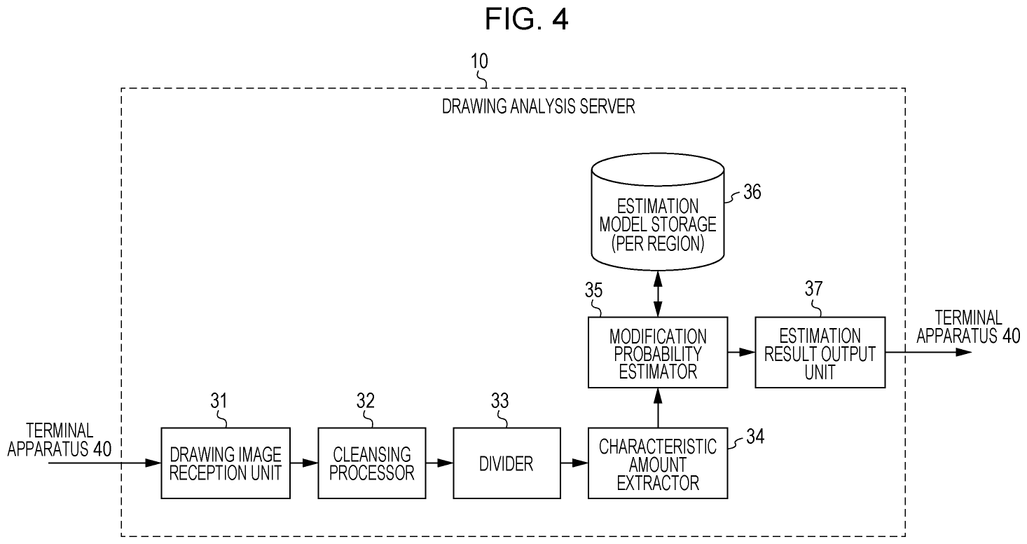

FIG. 4 is a block diagram illustrating the functional configuration of the drawing analysis server 10, implemented by executing the above-mentioned program.

As illustrated in FIG. 4, the drawing analysis server 10 in the exemplary embodiment includes a drawing image reception unit 31, a cleansing processor 32, a divider 33, a feature value extractor 34, a modification probability estimator 35, an estimation model storage 36 and an estimation result output unit 37.

The drawing analysis server 10 in the exemplary embodiment divides a drawing image with modified portions shown into a plurality of regions, and generates and pre-stores, in the estimation model storage 36, an estimation model to estimate a probability value of modification per region in the drawing by performing machine learning using a position of a region including a modified portion on the drawing, and a feature value extracted from an image of each region as teacher data.

The drawing image reception unit 31 receives a drawing image to be inspected transmitted from the terminal apparatus 40.

As preprocessing, the cleansing processor 32 performs cleansing processing of deleting various information from the drawing image received by the drawing image reception unit 31, the various information including frame lines, notes, dates, component numbers, lead lines, history information, copyright notices, and modification notices. Note that the drawing image is often a monochrome binary image. When a drawing image is a multi-value image or a color image, as the preprocessing, processing to convert the drawing image into a monochrome binary image is performed.

The divider 33 divides the drawing image to be inspected, which has undergone the cleansing processing performed by the cleansing processor 32, into a plurality of rectangular regions, for example.

The feature value extractor 34 extracts feature values from the images of the regions divided by the divider 33 to generate vector data.

Specifically, when an electrical circuit drawing image is received as a drawing image to be inspected, the feature value extractor 34 extracts as feature values, information on at least one of the type and number of electrical components, the number of wire connections and the number of unmounted component notices in the received electrical circuit drawing image.

For example, when the drawing image to be inspected is an electrical circuit drawing image, the feature value extractor 34 extracts, as the feature values, the number of capacitors, the number of resistors, the number of power supplies, the number of external connectors, the number of wire connections, the number of switches, the number of diodes, the number of transistors, and the number of NONASSY notices from the drawing image, and generates vector data.

Here, NONASSY notice refers to unmounted component notice which indicates that a component is not mounted. For a component labeled with a NONASSY notice, a wire pattern to allow a component to be mounted is formed on a printed circuit board. Thus, even when a component is added to a position where NONASSY notice is labeled due to design change in the future, the electrical circuit drawing only needs to be changed, and the printed circuit board does not need to be changed. A skilled designer tries to reduce the time and effort when design is changed by providing a component with a NONASSY notice at a position where a component is likely to be added in the future.

When a plastic component drawing image or a sheet metal component drawing image is received as a drawing image to be inspected, the feature value extractor 34 extracts as feature values, information on at least one of component name, material, area of planar portion, outer periphery length of component and the number of curved portions in the received plastic component drawing image or sheet metal component drawing image.

In addition, when the drawing image to be inspected is a plastic component drawing image or a sheet metal component drawing image, the feature value extractor 34 may calculate values indicating the degrees of complexity of the figures of the components in the drawing image, and may use the calculated values of the degrees of complexity of the figures as the feature values. Specifically, the feature value extractor 34 calculates “periphery length×periphery length/area” of a component in the drawing image as a value indicating the degree of complexity of the figure. In addition to the degree of complexity of the figure calculated by “periphery length×periphery length/area”, the feature value extractor 34 may use Hausdorff dimension, periphery length, the number of regions, and structure as the degree of complexity of the figure. Note that the “structure” here refers to a relationship of “including”, “included” between regions.

When a value indicating the degree of complexity of a component in a drawing image is used as a feature value, the size, and resolution of the drawing are normalized as the preprocessing for the drawing to be inspected. More specifically, enlargement processing or reduction processing is executed on a received drawing to be inspected to achieve predetermined size, and resolution.

In addition, also when a drawing image to be inspected is an electrical circuit drawing, the degree of complexity of a figure may be included as a feature value. The degree of complexity in an electrical circuit drawing may be calculated by the expression as shown below.

The degree of complexity=(the number of components+1)×(the number of wire connections+1)×(the number of power supply connections)×(the number of external wire connections+1)

When a drawing image to be inspected is a plastic component drawing image, the feature value extractor 34 may extract the material, the component name of the plastic component, and the area of planar portion as the feature values. If a plastic component has a large area of planar portion, due to lack of strength, there is often a high probability of modification, such as adding a rib or the like, or increasing a thickness. In addition, a component having a long outer periphery length, and a component having a greater number of curved portions also have a higher probability of modification, as compared to a component having a short outer periphery length, and a component having a smaller number of curved portions. Therefore, it is possible to estimate the probability of modification of a component by using the area of planar portion, the outer periphery length and the like of a component as feature values.

In order determine what kind of values should be extracted as the feature values, the type of the drawing image to be inspected needs to be determined. For this reason, the feature value extractor 34 estimates the type of the drawing image, for example, from information, such as the component numbers, the component names, and notes included in the drawing.

In addition, an assembly drawing may serve as a drawing image to be inspected. An assembly drawing is a drawing that illustrates an assembly procedure for producing one or more components by combining multiple subcomponents. Thus, due to design change of the components to be combined, an assembly drawing may need to be modified. When the drawing image to be inspected is an assembly drawing, the feature value extractor 34 extracts information such as the shapes of components, the shapes of junctions, and procedure instructions via a natural language as the feature values, and generates vector data.

For example, if a buffer material was needed at a junction in a similar shape in the past, and no buffer material is provided in the assembly drawing, design change of adding a buffer material is more likely to occur. If deformation occurred in an assembly component with a certain shape, and design change was made as a countermeasure in the past, and yet no countermeasure is taken in an assembly drawing including an assembly component with a shape similar to the past assembly component, design change is more likely to occur.

The modification probability estimator 35 estimates the probability value per region in the received drawing image by inputting the feature values extracted by the feature value extractor 34 to an estimation model stored in the estimation model storage 36.

When a drawing image is divided into multiple regions by the divider 33, portions with a high probability of modification may distribute over multiple regions. In this case, even when the probability of modification is estimated only from the feature values of each region, the probability of modification may be determined to be low. Thus, the modification probability estimator 35 selects one of multiple regions into which the drawing image is divided by the divider 33, as a region of interest, and estimates the probability value of the region of interest from multiple probability values obtained by inputting feature values of surrounding multiple regions including the selected region of interest to the estimation model stored in the estimation model storage 36.

For example, the modification probability estimator 35 estimates the probability value indicating the probability of modification for a set of 3×3 regions, that is, nine regions centered at one region of interest among multiple regions into which the drawing image is divided by the divider 33.

In this case, adjacent regions are combined, and processing is performed for a set of 3×3 regions, and the end region of the drawing image may have no adjacent regions. In such a case, the processing is performed for a set of 3×3 regions by padding and embedding white images.

When such processing is performed, for one region of interest, the probability values for nine regions including the region of interest are obtained from the estimation model.

The modification probability estimator 35 may perform the processing for a set of 5×5 regions, or for a set of 9×9 regions. In this manner, the modification probability estimator 35 performs the processing for a set of (odd number)×(odd number) multiple regions, thereby facilitating the processing for calculating the feature values of one region of interest.

Thus, the modification probability estimator 35 estimates the minimum value of multiple probability values as the probability value of the region of interest, the multiple probability values being obtained by inputting the feature values of multiple regions including the region of interest to the estimation model.

Here, as a method of calculating the probability value of the region of interest from multiple probability values obtained from the estimation model, various calculation methods may be used: a method of calculating the average value of the multiple probability values, a method of calculating the median of the multiple probability values, and a method of calculating the maximum value of the multiple probability values. The reason why the minimum value of the multiple probability values is calculated as the probability value of the region of interest in the exemplary embodiment will be described later.

The estimation result output unit 37 outputs the probability value of each region estimated by the modification probability estimator 35 on the drawing image to be inspected. For example, the estimation result output unit 37 displays regions with the estimated probability value higher than or equal to a predetermined threshold in a display mode different from that of other regions.

Next, the operation of the drawing analysis server 10 in the exemplary embodiment will be described in detail with reference to the drawings.

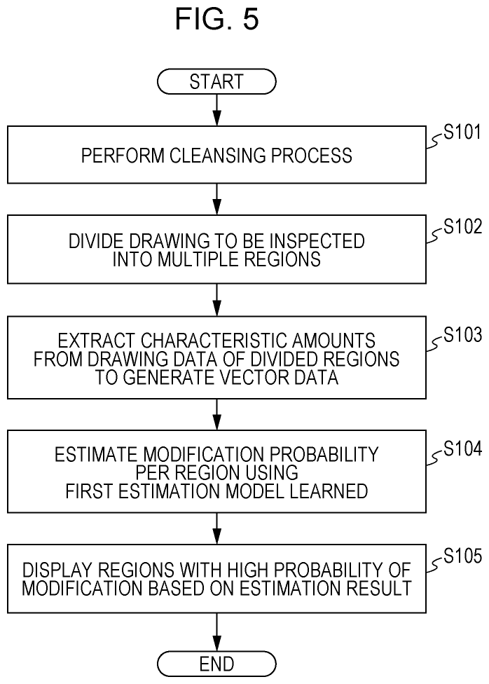

The flowchart of FIG. 5 illustrates the flow of processing for estimating a probability of modification per region in the drawing image to be inspected by the drawing analysis server 10 in the exemplary embodiment.

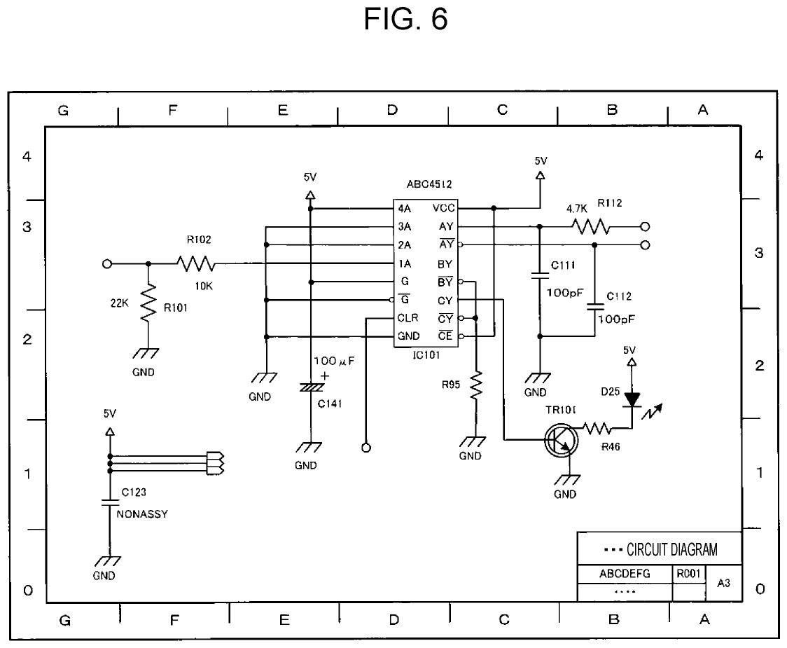

FIG. 6 illustrates a drawing image example to be inspected used for explaining the operation of the drawing analysis server 10 in the exemplary embodiment.

In the drawing analysis server 10, drawing image data transmitted from the terminal apparatus 40 is received by the drawing image reception unit 31. In step S101, as preprocessing, the cleansing processor 32 performs cleansing processing of deleting various information such as frame lines, notes, dates from the drawing image received by the drawing image reception unit 31.

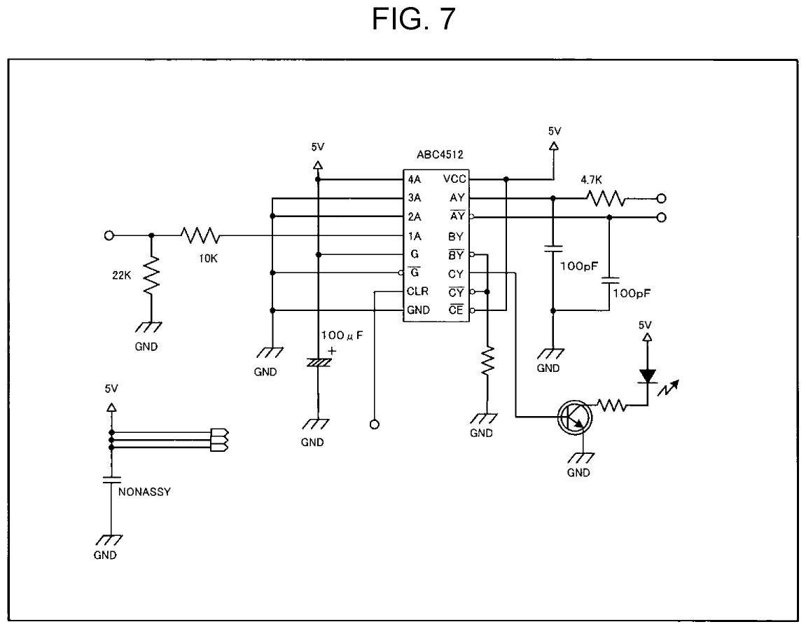

FIG. 7 illustrates a drawing image example which has undergone the cleansing processing in this manner. Referring to FIG. 7, it is seen that information on objects other than the electrical circuit, such as frame lines, has been deleted from the drawing image to be inspected illustrated in FIG. 6.

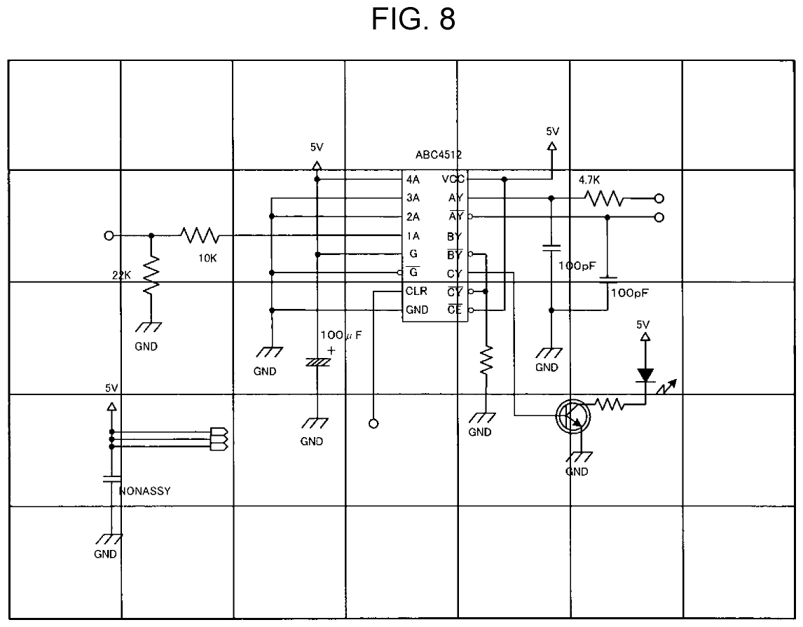

Next, in step S102, the divider 33 divides the drawing image to be inspected, which has undergone the cleansing processing performed by the cleansing processor 32, into a plurality of rectangular regions, for example. FIG. 8 illustrates a division example in which the divider 33 divides the drawing image into multiple regions.

Referring to FIG. 8, the drawing image is in a state of being divided into seven parts in a horizontal direction, and divided into five parts in a vertical direction. For the sake of simplicity of explanation, FIG. 8 illustrates the case where the drawing image is divided into 35 parts, as an example; however, the drawing image is divided into much more regions as a practical matter.

Next, in step S103, the feature value extractor 34 extracts, from the images of the regions divided by the divider 33, feature values showing the characteristics of the electrical circuit diagram, such as the number of capacitors, the number of resistors, the number of power supplies, the number of external connectors, the number of wire connections, and generates vector data.

Next, in step S104, the modification probability estimator 35 estimates the probability of modification per region in the received drawing image by inputting the feature values extracted by the feature value extractor 34 to an estimation model (corresponding to the first estimation model) stored in the estimation model storage 36.

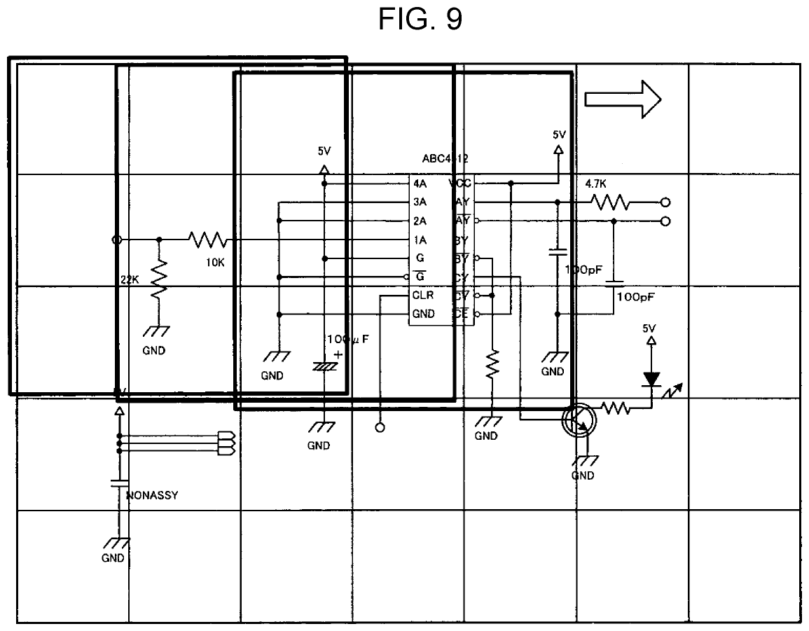

Specifically, as illustrated in FIG. 9, the modification probability estimator 35 makes evaluation for a set of nine regions included in the frame for 3×3 that is nine regions on the drawing image while sliding the frame, and calculates the probability value of modification. For a position where no drawing image is present in the frame of 3×3 regions, the modification probability estimator 35 embeds a blank image in the position with no drawing image present, and makes evaluation.

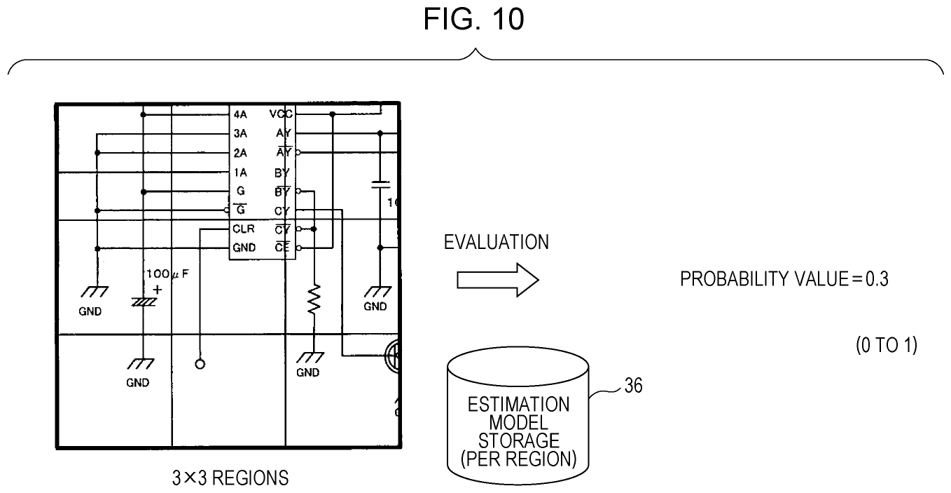

Specifically, as illustrated in FIG. 10, the modification probability estimator 35 calculates the probability value of modification for a set of nine regions by inputting vector data of the feature values to an estimation model pre-stored in the estimation model storage 36. FIG. 10 illustrates an example in which when an electrical circuit diagram for 3×3 regions is evaluated, a probability value of 0.3 is calculated. In the exemplary embodiment, a case will be described in which for example, a value in a range from 0 to 1 is calculated as the probability value of modification. The probability value of 0 shows that there is no probability of modification, and the probability value closer to 1 indicates that the probability of modification is higher. The greater the probability value, the higher the probability of modification of an electrical circuit diagram in evaluated 3×3 regions.

In this manner, when the probability value of modification is calculated for a set of 3×3 regions, attempt to obtain the probability value of one region selected as the region of interest requires calculation of nine probability values.

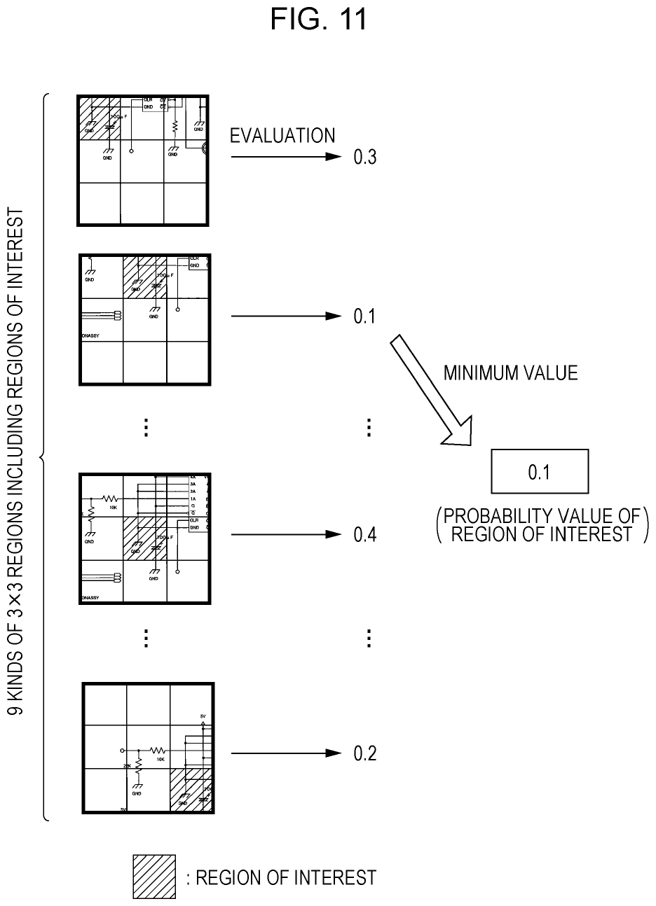

Specifically, as illustrated in FIG. 11, there are nine frames for 3×3 regions including a certain region of interest, nine probability values for nine regions including the one region of interest are obtained. Thus, the modification probability estimator 35 can estimate any of various values such as the average value, the maximum value, the minimum value, and the median of nine probability values obtained, as the probability value of the region of interest. However, in the exemplary embodiment, the minimum value of nine probability values obtained is estimated as the probability value of the region of interest. Note that the probability value of the region of interest may be calculated from nine probability values using Dempster's rule of combination or Bayesian method.

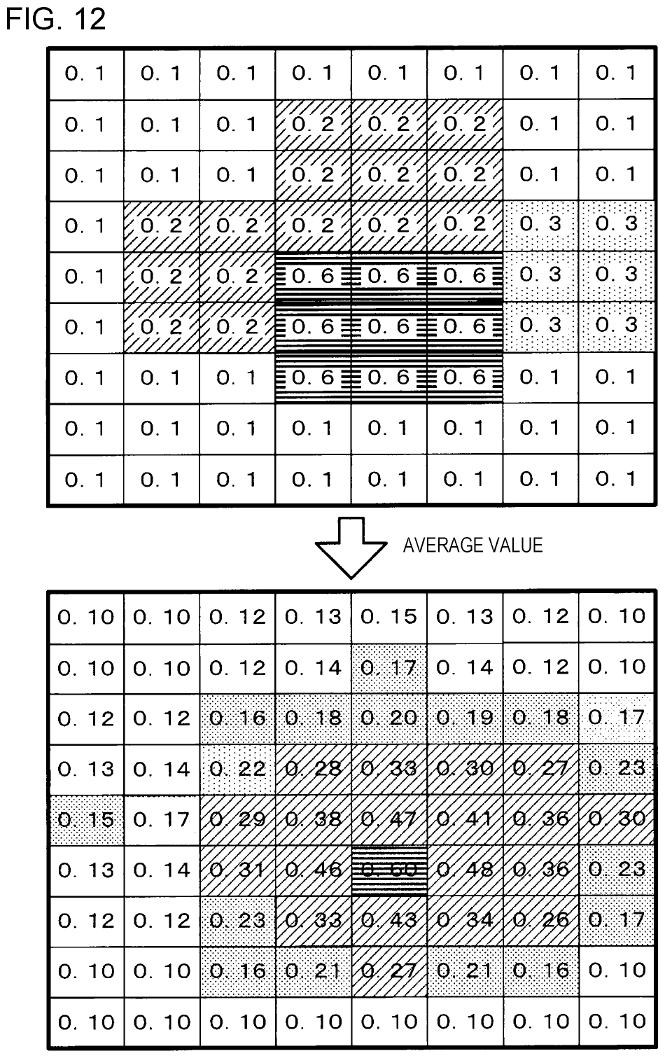

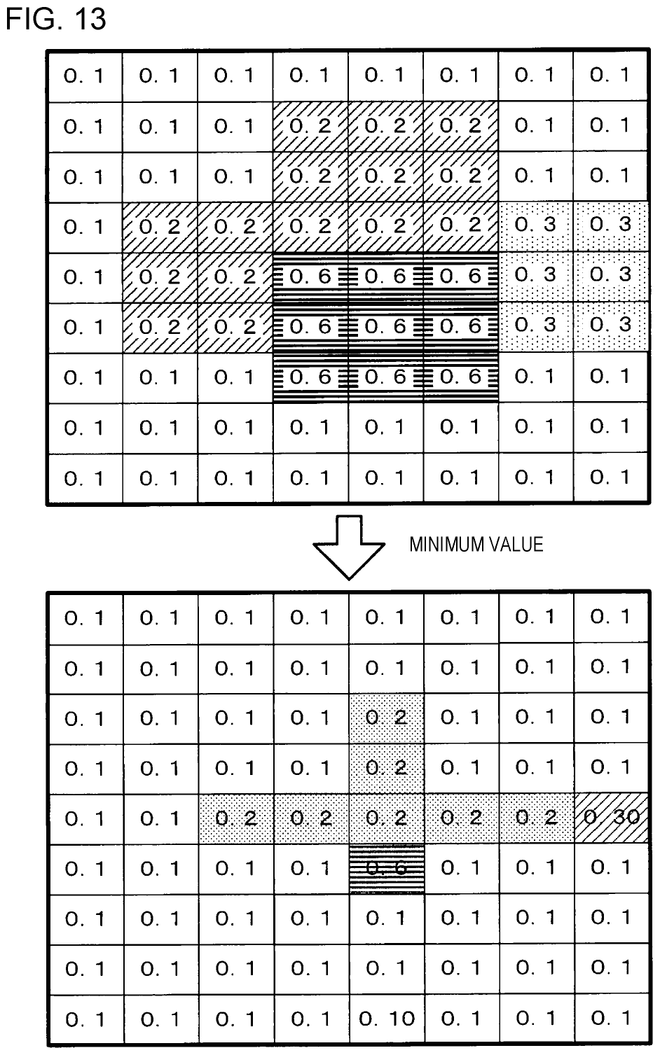

The reason why the calculation method of selecting the minimum value of nine probability values is used as a method of calculating the probability value of the region of interest will be described with reference to FIG. 12, FIG. 13.

FIG. 12 is a chart illustrating a calculation example in which an average value is calculated from estimation results obtained when probability values are each estimated for a set of nine regions, and a probability value for each region is estimated. FIG. 13 is a chart illustrating a calculation example in which a minimum value is calculated from estimation results obtained when probability values are each estimated for a set of nine regions, and a probability value for each region is estimated.

In the first place, in a drawing for which certain quality is ensured, a portion with a probability of modification occurs significantly less frequently than a portion with no probability of modification. The end portion of the drawing is often a blank image having no information, and naturally, there is no probability of modification. Therefore, in many regions, it is estimated that there is almost no probability of modification. Thus, when the average value of nine probability values is estimated as the probability value of the region of interest, change across regions is gentle, and it is difficult to tell which region truly has a high probability of modification.

In contrast, when the minimum value of nine probability values is estimated as the probability value of the region of interest, it is possible to precisely determine which region has a high probability of modification. From the view point of psychology of a user, the regions which need to be reviewed can be recognized more clearly in a situation where regions with a high probability value are present in a narrow range in a concentrated manner rather than in a situation where regions with a certain high probability value are present in a wide range. A user is also expected to review the surrounding drawing portions including the regions which are determined to have a high probability of modification, thus precisely showing the regions with a high probability of modification to a user in this manner achieves further improvement of the drawing accuracy.

Specifically, in FIG. 12 in which the average value is calculated from estimation results obtained when probability values are each estimated for a set of nine regions, and a probability value for each region is estimated, many regions where a probability value in a range of 0.3 to 0.48 are also present around a region where a value of “0.6” is calculated as a probability value. Thus, when the regions with a high probability of modification are shown to a user, it is difficult to recognize which regions should be shown as the regions to be reviewed.

In contrast, in FIG. 13 in which the minimum value is calculated from estimation results obtained when probability values are each estimated for a set of nine regions, and a probability value for each region is estimated, the probability value is substantially 0.1 or 0.2 in the regions around the regions where a value of “0.6” is calculated as a probability value. Thus, when the regions with a high probability of modification are shown to a user, it is possible to precisely show the regions to be reviewed. Referring to FIG. 13, it is possible to recognize that the region where a value of “0.3” is calculated as a probability value should be reviewed subsequent to the regions where a value of “0.6” is calculated as a probability value.

In this manner, when the probability value of each of the divided regions of the drawing image is estimated by the modification probability estimator 35, in step S105, the estimation result output unit 37 outputs the regions with a high probability of modification based on the results of the estimation.

Specifically, the estimation result output unit 37 determines that the regions with 0.4 or higher probability value estimated by the modification probability estimator 35 have a high probability of modification, and transmits a drawing image to the terminal apparatus 40 as an evaluation result, the drawing image having the regions displayed in a display mode different from that of other regions.

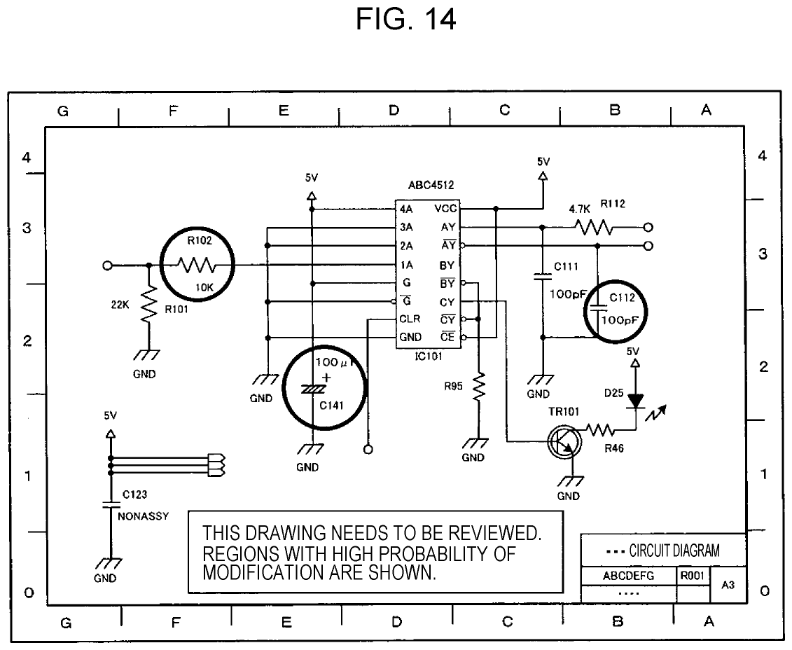

An evaluation result example output by the estimation result output unit 37 in this manner is illustrated in FIG. 14. Referring to FIG. 14, an example is illustrated in which the regions with 0.4 or higher estimated probability value are highlighted, and the sentence, “THIS DRAWING NEEDS TO BE REVIEWED. REGIONS WITH HIGH PROBABILITY OF MODIFICATION ARE SHOWN.” is added on the drawing image.

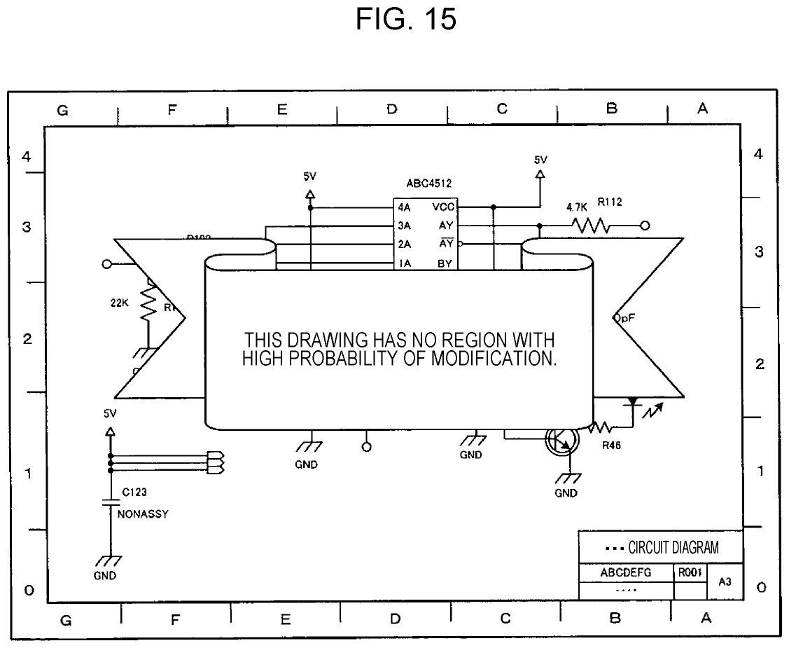

An evaluation result example when there is no region with 0.4 or higher probability value estimated by the modification probability estimator 35 is illustrated in FIG. 15. In the evaluation result example illustrated in FIG. 15, the sentence, “THIS DRAWING HAS NO REGION WITH HIGH PROBABILITY OF MODIFICATION.” is added on the drawing image.

In the above-described exemplary embodiment, a description has been given using the case where a drawing to be inspected is an electrical circuit drawing. However, the drawing inspection work support system 100 in the exemplary embodiment can evaluate drawings of a type different from an electrical circuit drawing.

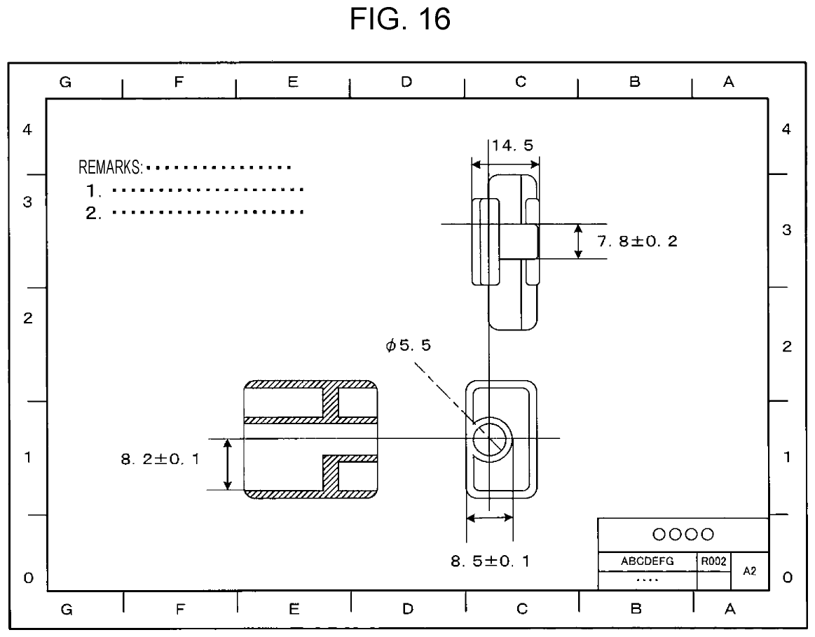

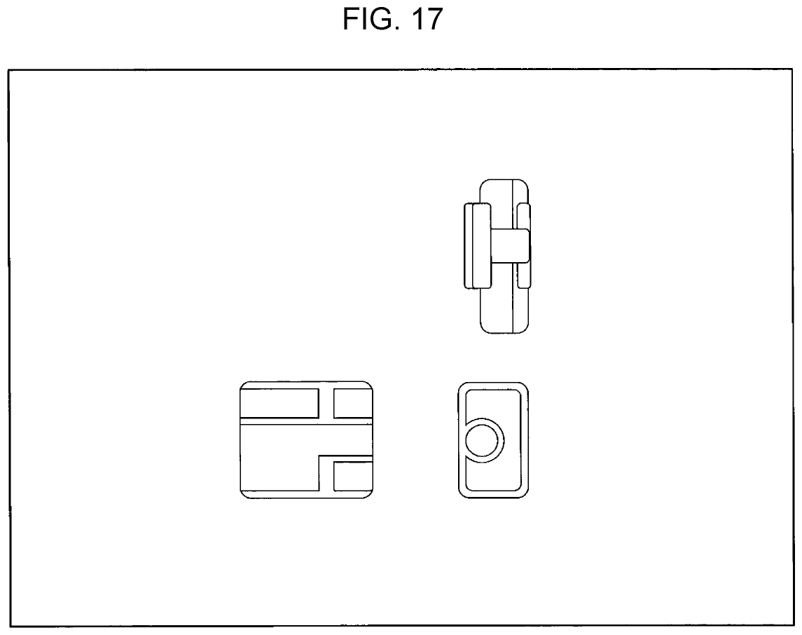

For example, the case where the drawing to be inspected is a plastic component drawing is illustrated in FIG. 16. When a plastic component drawing as illustrated in FIG. 16 is received as the drawing to be inspected, a processing result example after the drawing analysis server 10 executes the cleansing processing as the preprocessing is illustrated in FIG. 17.

When the drawing to be inspected is a plastic component drawing, as the preprocessing, the cleansing processor 32 deletes frame lines, notes, date information, component numbers, and dimension lines from the drawing image. Even when the drawing to be inspected is a sheet metal component drawing or an assembly drawing, the cleansing processor 32 performs similar processing to delete various supplemental information such as frame lines, notes, date information, and component numbers from the drawing image, and performs the cleansing processing.

### Second Exemplary Embodiment

Next, a drawing inspection work support system in a second exemplary embodiment of the present disclosure will be described.

The above-described drawing inspection work support system 100 in the first exemplary embodiment of the present disclosure estimates which regions in one sheet of drawing image have a high probability of modification, and shows the regions to a user.

However, in the first place, when the probability of modification of one entire sheet of drawing image is not high, the probability of modification of the divided regions of the drawing image is also considered to be not high. Also, when the probability of modification of one entire sheet of drawing image is high, the probability of modification of one of the multiple regions obtained by dividing the drawing image is considered to be high.

Thus, in the drawing inspection work support system in the present exemplary embodiment, the probability of modification of the entire drawing image, and the probability of modification per region obtained by dividing each drawing image are combined, and the probability of modification of each region is estimated.

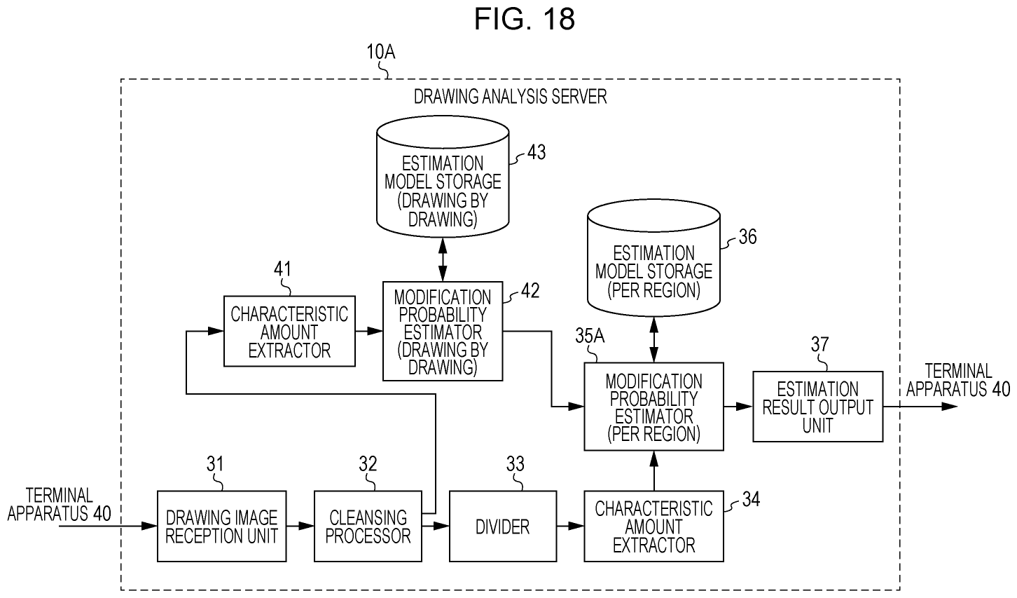

The drawing inspection work support system in the present exemplary embodiment has a configuration in which the drawing analysis server 10 is replaced by a drawing analysis server 10A illustrated in FIG. 18 in the drawing inspection work support system 100 in the first exemplary embodiment illustrated in FIG. 1.

As illustrated in FIG. 18, the drawing analysis server 10A in the present exemplary embodiment has a configuration in which a feature value extractor 41, a modification probability estimator 42, and an estimation model storage 43 are added to the drawing analysis server 10 illustrated in FIG. 4, and the modification probability estimator 35 is replaced by a modification probability estimator 35A.

The drawing analysis server 10A in the present exemplary embodiment generates and stores, in the estimation model storage 43, a second estimation model to estimate a probability value of modification per drawing by performing machine learning using respective feature values extracted from multiple drawing images with modified portions shown, and information on the presence or absence of a modified portion in the multiple drawing images as teacher data.

Note that in the following description, an estimation model which is stored in the estimation model storage 36 to estimate a probability indicating a probability of modification per region may be called the first estimation model, and an estimation model which is stored in the estimation model storage 43 to estimate a probability indicating a probability of modification per drawing may be called the second estimation model.

The feature value extractor 41 extracts feature values from drawing images which have undergone the cleansing processing performed by the cleansing processor 32, and generates vector data. Note that the feature value extracted from a drawing image by the feature value extractor 41 in the present exemplary embodiment is the same as the feature value extracted from the regions divided by the feature value extractor 34 described in the first exemplary embodiment.

The modification probability estimator 42 estimates the probability value of the received drawing image by inputting the feature values extracted from the received drawing image by the feature value extractor 41 to the second estimation model stored in the estimation model storage 43.

The modification probability estimator 35A estimates the probability of modification in each of the divided regions of the drawing image by using the probability value for the entire drawing image estimated by the second estimation model, and the probability value per region estimated by the first estimation model stored in the estimation model storage 36.

For example, when the probability value per region estimated by the first estimation model is higher than a first threshold, and the probability value for the entire drawing image estimated by the second estimation model is higher than a second predetermined threshold, the modification probability estimator 35A estimates that the probability of modification is high in each of the divided regions of the drawing image.

Let Ps be the estimated probability value per drawing, and let Pp be the estimated probability value per region. Specifically, when the expression below is satisfied, the modification probability estimator 35A estimates that the probability of modification in the region is high.

(0.8<Ps and 0.2<Pp) or (0.5≤Ps and 0.3<Pp)

In other words, when the estimated probability per drawing is higher than 0.8, the modification probability estimator 35A determines that the probability of modification in some region of the drawing is pretty high, and even when the probability value of modification in the region is higher than 0.2, the modification probability estimator 35A determines that the probability of modification in the region is high. When the estimated probability per drawing is higher than or equal to 0.5, the modification probability estimator 35A determines that there is a probability of modification in some region of the drawing, and when the probability value of modification in the region is higher than 0.3, the modification probability estimator 35A determines that the probability of modification in the region is high.

Conversely, even when the probability value which is estimated by the second estimation model and indicates the probability of modification per region is high, if the probability value indicating the probability of modification of the entire drawing is low, the modification probability estimator 35A determines that the probability of modification in the region is low.

A method of determining whether the probability of modification of each region is high or low by combining the probability of modification per drawing, and the probability of modification per region is not limited to the above-described method, and various calculation methods and determination methods may be used.

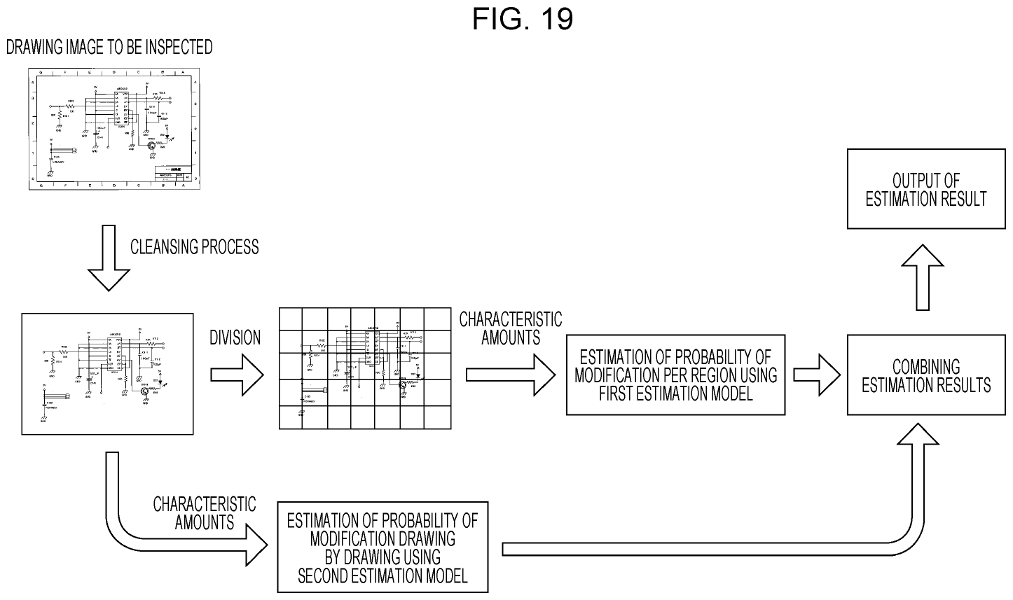

Next, FIG. 19 illustrates an overview of the flow of processing in the drawing analysis server 10A in the present exemplary embodiment.

First, the drawing image to be inspected undergoes the cleansing processing performed by the cleansing processor 32, and becomes image data with information such as frame lines and notes deleted.

In the modification probability estimator 42, the probability of modification per drawing is estimated by inputting the feature values of the entire drawing image after the cleansing processing to the second estimation model stored in the estimation model storage 43, the feature values being extracted by the feature value extractor 41.

The drawing image after the cleansing processing is divided into multiple regions by the divisor 33. The feature values for respective regions are extracted by the feature value extractor 34. The modification probability estimator 35A estimates the probability of modification per region by inputting the feature values per region to the first estimation model stored in the estimation model storage 36. Furthermore, the modification probability estimator 35A estimates the probability of modification in each region by combining the estimated probability of modification per region, and the estimated probability of modification per drawing estimated by the modification probability estimator 42.

Finally, the estimation result output unit 37 outputs the finally estimated results of probability of modification in each region onto the original drawing image, and transmits the estimated results to the terminal apparatus 40.

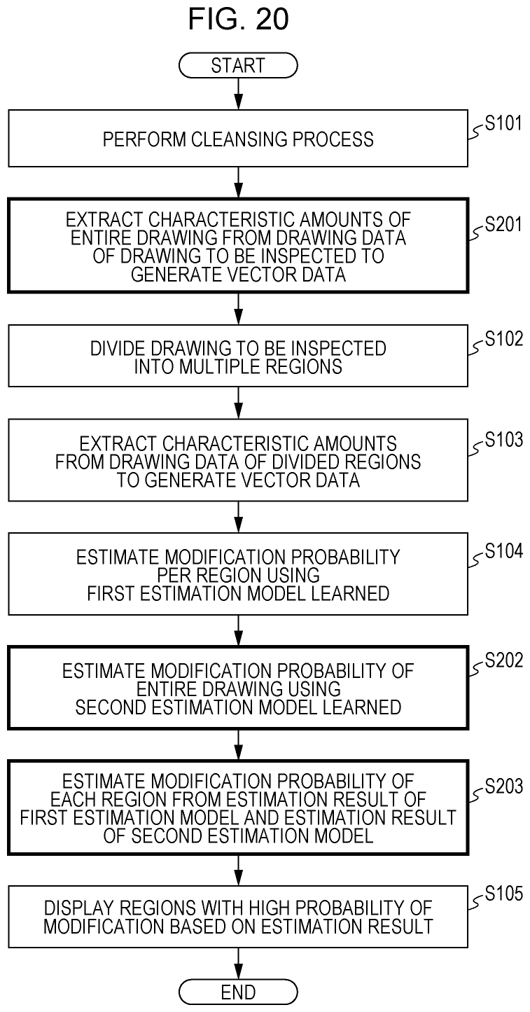

Next, the flowchart of FIG. 20 illustrates the flow of processing for estimating a probability of modification per region in the drawing image to be inspected by the drawing analysis server 10A in the present exemplary embodiment.

The flowchart illustrated in FIG. 20 is such that the processing in steps S201 to S203 is added to the flowchart showing the flow of processing in the drawing analysis server 10 in the first exemplary embodiment illustrated in FIG. 5. Thus, in the following description, only the processing of the added steps S201 to S203 will be described.

In step S201, the feature value extractor 41 extracts the feature values for the entire drawing image to be inspected after the cleansing processing, and generates vector data.

In step S202, the modification probability estimator 42 estimates the probability of modification for the entire drawing by inputting the vector data of the feature values extracted by the feature value extractor 41 to the second estimation model stored in the estimation model storage 43.

In step S203, the modification probability estimator 35A estimates the probability of modification in each region from the estimation results, estimated in step S202, of the second estimation model, and the estimation results, estimated in step S104, of the first estimation model.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory; and
a processor configured to:
divide a drawing image with one or more modified portions shown into a plurality of regions, and generate and store, in the memory, a first estimation model to estimate a probability value of modification per region in a drawing by performing machine learning using, as teacher data, a position of a region including a modified portion on the drawing, and a feature value extracted from an image of each of the plurality of regions;
divide, upon receiving a drawing image to be inspected, the received drawing image into a plurality of regions, and extract a feature value from an image of each of the divided regions; and
estimate a probability value per region in the received drawing image by inputting the extracted feature value to the first estimation model stored in the memory.

2. The information processing apparatus according to claim 1,
wherein the processor is configured to select one of the plurality of regions divided in the drawing image as a region of interest, and estimate a probability value of the region of interest from a plurality of probability values obtained by inputting feature values of surrounding multiple regions including the selected region of interest to the first estimation model.

3. The information processing apparatus according to claim 2,
wherein the processor is configured to estimate, as a probability value of a region of interest, a minimum value of a plurality of probability values obtained by inputting feature values of multiple regions including the region of interest to the first estimation model.

4. The information processing apparatus according to claim 1,
wherein the processor is configured to display a region with the estimated probability value higher than or equal to a predetermined threshold in a display mode different from a display mode of other regions.

5. The information processing apparatus according to claim 2,
wherein the processor is configured to display a region with the estimated probability value higher than or equal to a predetermined threshold in a display mode different from a display mode of other regions.

6. The information processing apparatus according to claim 3,
wherein the processor is configured to display a region with the estimated probability value higher than or equal to a predetermined threshold in a display mode different from a display mode of other regions.

7. The information processing apparatus according to claim 1,
wherein the processor is configured to extract, upon receiving an electrical circuit drawing image as the drawing image to be inspected, information on at least one of type and number of electrical components, number of wire connections, and number of unmounted component notices as a feature value in the received electrical circuit drawing image.

8. The information processing apparatus according to claim 2,
wherein the processor is configured to extract, upon receiving an electrical circuit drawing image as the drawing image to be inspected, information on at least one of type and number of electrical components, number of wire connections, and number of unmounted component notices as a feature value in the received electrical circuit drawing image.

9. The information processing apparatus according to claim 3,
wherein the processor is configured to extract, upon receiving an electrical circuit drawing image as the drawing image to be inspected, information on at least one of type and number of electrical components, number of wire connections, and number of unmounted component notices as a feature value in the received electrical circuit drawing image.

10. The information processing apparatus according to claim 4,
wherein the processor is configured to extract, upon receiving an electrical circuit drawing image as the drawing image to be inspected, information on at least one of type and number of electrical components, number of wire connections, and number of unmounted component notices as a feature value in the received electrical circuit drawing image.

11. The information processing apparatus according to claim 5,
wherein the processor is configured to extract, upon receiving an electrical circuit drawing image as the drawing image to be inspected, information on at least one of type and number of electrical components, number of wire connections, and number of unmounted component notices as a feature value in the received electrical circuit drawing image.

12. The information processing apparatus according to claim 6,
wherein the processor is configured to extract, upon receiving an electrical circuit drawing image as the drawing image to be inspected, information on at least one of type and number of electrical components, number of wire connections, and number of unmounted component notices as a feature value in the received electrical circuit drawing image.

13. The information processing apparatus according to claim 1,
wherein the processor is configured to extract, upon receiving a plastic component drawing image or a sheet metal component drawing image as the drawing image to be inspected, information on at least one of component name, material, area of planar portion, outer periphery length of component, and number of curved portions as a feature value in the received plastic component drawing image or sheet metal component drawing image.

14. The information processing apparatus according to claim 2,
wherein the processor is configured to extract, upon receiving a plastic component drawing image or a sheet metal component drawing image as the drawing image to be inspected, information on at least one of component name, material, area of planar portion, outer periphery length of component, and number of curved portions as a feature value in the received plastic component drawing image or sheet metal component drawing image.

15. The information processing apparatus according to claim 3,
wherein the processor is configured to extract, upon receiving a plastic component drawing image or a sheet metal component drawing image as the drawing image to be inspected, information on at least one of component name, material, area of planar portion, outer periphery length of component, and number of curved portions as a feature value in the received plastic component drawing image or sheet metal component drawing image.

16. The information processing apparatus according to claim 4,
wherein the processor is configured to extract, upon receiving a plastic component drawing image or a sheet metal component drawing image as the drawing image to be inspected, information on at least one of component name, material, area of planar portion, outer periphery length of component, and number of curved portions as a feature value in the received plastic component drawing image or sheet metal component drawing image.

17. The information processing apparatus according to claim 1,
wherein the processor is configured to:
generate and store, in the memory, a second estimation model to estimate a probability value of modification per drawing by performing machine learning using, as teacher data, respective feature values extracted from a plurality of drawing images with a modified portion shown, and information on presence or absence of a modified portion in the plurality of drawing images;
estimate a probability value of the received drawing image by inputting feature values extracted from the received drawing image to the second estimation model stored in the memory; and
estimate a probability of modification in each of regions divided in the received drawing image by using a probability value for the entire received drawing image estimated by the second estimation model, and a probability value per region estimated by the first estimation model.

18. The information processing apparatus according to claim 17,
wherein the processor is configured to estimate, when the probability value per region estimated by the first estimation model is higher than a first threshold, and the probability value for the entire received drawing image estimated by the second estimation model is higher than a second predetermined threshold, that a probability of modification is high in each of the divided regions of the received drawing image.

19. A non-transitory computer readable medium storing a program causing a computer to execute a process comprising:
dividing a drawing image with one or more modified portions shown into a plurality of regions, and generating and storing a first estimation model to estimate a probability value of modification per region in a drawing by performing machine learning using, as teacher data, a position of a region including a modified portion on the drawing, and a feature value extracted from an image of each of the plurality of regions;
dividing, upon receiving a drawing image to be inspected, the received drawing image into a plurality of regions, and extracting a feature value from an image of each of the divided regions; and
estimating a probability value per region in the received drawing image by inputting the extracted feature value to the first estimation model.

20. An information processing method comprising:
dividing a drawing image with one or more modified portions shown into a plurality of regions, and generating and storing, in the memory, a first estimation model to estimate a probability value of modification per region in a drawing by performing machine learning using, as teacher data, a position of a region including a modified portion on the drawing, and a feature value extracted from an image of each of the plurality of regions;
dividing, upon receiving a drawing image to be inspected, the received drawing image into a plurality of regions, and extracting a feature value from an image of each of the divided regions; and
estimating a probability value per region in the received drawing image by inputting the extracted feature value to the first estimation model stored in the memory.
